(19) United States
(12) Patent Application Publication
(10) Pub. No.: US 2016/0001243 A1
(43) Pub. Date: Jan. 7, 2016

(54) MIXING SYSTEM FOR VISCOUS MEDIA

(71) Applicants: Dietmar WAIZENAUER, Kematen an der Krems (AT); Bernhard WAIZENAUER, Allhaming (AT)

(72) Inventors: Dietmar WAIZENAUER, Kematen an der Krems (AT); Bernhard WAIZENAUER, Allhaming (AT)

(21) Appl. No.: 14/646,420

(22) PCT Filed: Nov. 21, 2013
(86) PCT No.: PCT/AT2013/050225

§ 371 Date: Sep. 16, 2015

(30) Foreign Application Priority Data
Nov. 21, 2012 (AT) A 1233/2012

(51) Int. Cl. B01F 15/02; G05D 11/00; G05D 11/13; B01F 3/08; B01F 15/00

(52) U.S. Cl. CPC B01F 15/0201; B01F 3/0803; B01F 3/088; B01F 15/00136; B01F 15/00331; B01F 15/0243; B01F 15/026; G05D 11/132; G05D 11/005

(57) ABSTRACT

A mixing device for mixing at least two liquids is provided. The mixing device includes at least two conduits which are joined at a joining point to become a single conduit. At least one of the conduits has a flow control valve and a flow sensor. The flow control valve (4) and the flow sensor (5) are arranged in any order and in close proximity to each other.

### CROSS-REFERENCE TO RELATED APPLICATIONS

This application is a Section 371 of International Application No. PCT/AT2013/050225, filed Nov. 21, 2013, which was published in the German language on May 30, 2014, under International Publication No. WO 2014/078883 A2 and the disclosure of which is incorporated herein by reference.

### BACKGROUND OF THE INVENTION

The present invention relates to a mixing device for mixing at least two liquids.

The conveyor and mixing facilities available on the market use extrusion pumps (e.g., chop check pumps) as conveyor units. Depending on the manufacturer, these pumps are driven pneumatically, hydraulically or electrically. The material is extracted from barrels by feed pumps and delivered to a processing unit via tubing. The processing unit consists of a mixing block with check valves for each component, a common pressure reducing valve, and a blocking unit which blocks the flow of mixed materials to the production process. This means that the feed unit and the discharge unit are located at opposite ends of the transport conduit.

The mixing ratio at the processing unit is altered by altering the delivery pressure of each individual component. More exact systems have volumetric measuring devices which, depending on the manufacturer, are mounted before the processing unit or after the feed pumps. Each of these systems includes different transport paths of certain lengths in the form of supply tubes and hydraulic fittings between a measuring device (e.g., a sensor), the regulated conveyor (e.g., an actuator), and the processing unit (where the mixing takes place). Due to the dilatation of the supply tubes and the compressibility of the material within the supply tubes, the supply tubes store energy which can be defined as a dead-time element for control processes. The parameters of this dead-time element depend on the material's viscosity, the tube's dilatation, tube length, flow resistances within the hydraulic connections and fittings. It is difficult to implement the control process precisely, as it is difficult to establish a mathematical model of the control process in practice. PI or PID controllers are hardly able to react to changing material properties and have to be adjusted depending on the respective material in order to guarantee good or satisfactory functioning.

Piston-type feeding devices which deliver materials like syringes (each component individually), mix them in a controlled way using a servo drive for each material, and are directly mounted at the processing unit, are a special type of mixing device. The volume of each component is additionally measured by flow sensors. Additives are, for example, added discontinuously to the volumetric flow via pulsed dye valves. This is currently the most precise configuration available on the market. This mixing process is discontinuous, as the pistons' volume is limited. The process of adding the additive is not monitored. It is necessary to choose the right piston volume for the respective application. The arrangement is complicated and has a high weight. In addition, the acquisition of this arrangement is very expensive. It is currently used for applications requiring highly precise mixing ratios.

Principally, there are supply facilities having fixed mixing ratios and variable mixing ratios.

### Fixed/Constant Mixing Ratio of 1:1

The extrusion pump has to be coupled mechanically/hydraulically or electrically, to make sure that its position and thus the time when its direction of movement is changed, remain the same at any point in time. As the viscosity of components A and B may differ greatly, depending on the respective manufacturers, it is possible that the mixing ratio varies. In the extrusion pump's switching phase, the mixing ratio may vary significantly, as the feed units deliver an undefined amount of material in this position. In addition, it is not possible to take unevenly filled material containers into account, so that large quantities of one component are left over.

### Variable Mixing Ratio

In case of variable mixing ratios, it is additionally possible that the material level in the respective barrels influences the supplied quantities of each component to make sure that the containers are evenly emptied. When setting a variable mixing ratio, the delivery units of components A and B are not coupled to each other. Depending on the respective manufacturer, volumetric measuring devices may be integrated into the tube to control the supplied quantities. They are located directly at the delivery facility or the processing unit. In previous systems, the feed pump constitutes the control element which varies the pressure to alter the mixing ratio. The delivery pressure of current systems amounts to approximately 150 to 200 bar, depending on viscosity and tube length. To achieve a constant delivery pressure, a pressure reducing valve, which reduces the pressure within the facility to a constant value of 50 bar, for example, is integrated at the end of the tube after combining the two components.

### Adding Additives

According to the state of the art, additives are added via dye valves, a certain amount being added to the volumetric flow at certain intervals (i.e., discontinuously). The additive is filled into a piston and then injected into the volumetric flow in a pulsed manner. The volume which is added over time depends on the feeding stroke and the dosing piston's diameter. The feeding stroke and the piston diameter have to be mechanically adapted to the application (adjustable stroke). It is not monitored whether the piston's chamber is entirely filled by the feeding process nor whether the injected material is actually introduced into the volumetric flow. As the dye valves include check valves, it may be assumed that their opening and closing behavior is influenced by the materials' varying viscosities. Additionally, problems occur when these systems are not ventilated or when there is no material pressure acting on the dye valve.

Currently, most manufacturers use pulsed dye valves, with additives being added to the volumetric flow at the processing unit at an adjustable amount. The actual material flow is determined based on the piston's position (by calculating the volumetric flow) or by flow sensors. As material tubes and a feeding path are located between the dye valve and the measuring device (or the feeding pump when the volume is calculated), the elements acting like reservoirs or dead-time elements, the amount of additive added is very imprecise and not continuous if very small amounts are added. If measured over a longer period of time and if larger amounts are added, this way of adding additives achieves better results concerning accuracy. In each of these cases, additives are added discontinuously and without control. It is impossible to guarantee that a precise amount is added at any point in time.

An objective of the present invention is to provide a mixing device which overcomes the disadvantages of the imprecise control of different components of the prior art devices.

### BRIEF SUMMARY OF THE INVENTION

In one embodiment, the present invention relates to a mixing device comprising at least two conduits which are joined at a joining point to become a single conduit. At least one of the conduits has a flow control valve (e.g., throttle valve) and a flow sensor. The flow control valve and the flow sensor are arranged in any order and in close proximity to each other.

Using such a mixing device, it is possible to achieve an exact mixing ratio for each component and additive at any point in time; a non-intermittent, volumetric flow rate; and a continuous and limitless material flow. Liquids are delivered based on the “first in, first out” principle. That is, the liquid which is first introduced is also the first to be discharged again. This constitutes another advantage of the mixing device according to the present invention. The mixing ratio can be freely selected. The control system between the actuator (e.g., a flow control valve) and the sensor (e.g., a flow sensor) is reduced to a minimum, eliminating nearly all disturbing factors and dead-time elements within the control system. Thus, a very fast control loop which is able to immediately react to the slightest changes is created. The mixing ratio is adjusted directly at the mixing block which is situated very close to the final processing process. The mixing device according to the present invention achieves a correct mixing ratio at the mixing location at any point in time.

The phrase “in close proximity” refers to a distance of maximally 100 cm, preferably to a maximum distance of 50 cm, more preferably a maximum distance of 40 cm, and most preferably a maximum distance of 30 cm, 20 cm, 10 cm, or 5 cm. The term “distance” refers to the length of a conduit between the flow control valve and the flow sensor.

The phrase “in any order” means that it is possible to arrange the flow control valve before the flow sensor in the flow direction or to arrange the flow sensor before the flow control valve in the flow direction. Both orders are equally suited for the mixing process.

Additionally, the blocking unit may be eliminated, as the flow control valves are able to completely block the volumetric flow. The check valves may also be eliminated, as the flow direction of the individual components is measured by flow sensors and a detected backflow may be prevented, if need be, by the flow control valve. Thus, a mechanically simple, light-weight, space-saving, compact, and cost-efficient structure, which needs only a few mechanical components and works more precisely than those systems currently available on the market, is created. The number of components in contact with the mixed material is reduced, thus also reducing maintenance costs.

The addition of additives is measured and may be protocolled or is documented. Additives are added continuously, not intermittently as in current conventional systems.

It is also possible to include pulsed dye valves which feed the additives directly into the mixing block. The added amounts are more precise, as the current volumetric flows of the main components are measured at any point in time and the additive is added at the mixing location in real time.

Existing facilities may be subsequently fit with this mixing device, or it may be used as stand-alone facility or complete facility with feeding pumps. The type of feeding pump, such as a gear pump or an eccentric screw pump or an extrusion pump or a screw spindle pump or any other type of feeding pump, and the mode of driving it may be chosen freely and independently. To achieve the highest precision possible, the feeding pressure should be constant. The possibility to adjust the mixing ratio based on the levels within the material barrels may be integrated as a further feature (so that both barrels are completely empty in the end).

If two materials are mixed at the same feeding pressure and the measured feeding volume is adjusted, a highly exact mixing ratio may be achieved, independently of materials' viscosities.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows a mixing device according to an embodiment of the present invention, wherein the arrows indicate the flow directions of the components; and

FIG. 2 shows a system according to an embodiment of the present invention, which includes feeding devices for emptying containers in addition to the mixing device and which allows for adding additives, wherein the arrows indicate the flow directions of the components.

### DETAILED DESCRIPTION OF THE INVENTION

The present invention relates to a mixing device for mixing at least two liquids. The mixing device comprises at least two conduits which are joined at a joining point to become a single conduit. In one embodiment, each conduit may have a flow control valve and a flow sensor, the flow control valve and the flow sensor being arranged in any order and in close proximity to each other. If every conduit includes a flow sensor and a flow control valve, it is possible to exactly adjust the amount of liquid in each conduit, making it possible to achieve an even more exact mixing ratio.

In one embodiment of the present invention, the distance between the flow control valve and the flow sensor may be defined as the ratio of the conduit's length to its diameter, amounting to a maximum ratio of 70:1, preferably a maximum ratio of 50:1, and more preferably a maximum ratio of 30:1. These ratios reflect the conduit's maximum length in relation to its diameter. If the ratio of the conduit's length to its diameter is 70:1, it is possible to achieve excellent mixing. For example, if the conduit is 1 m long, its diameter is maximally 14.3 mm. A ratio of 50:1 is preferred and a ratio of 30:1 is particularly preferred, since an even better mixing may be achieved at these ratios. However, it will be understood that the maximum ratio may also be 60:1, 40:1, 20:1, 10:1, 5:1, 4:1, 3:1, 2:1, or 1:1.

In one embodiment of the present invention, the flow meter and the flow control valve may be arranged in any order directly adjacent to each other. This is the shortest distance possible, resulting in a quick control of flow rate by adjusting the flow control valve. The flow meter may, for example, be arranged directly before the flow control valve in the flow direction, or it may be located directly after the flow control valve in the flow direction. This arrangement may also be implemented in an integrated fashion, for example, drilled into a steel block.

In another embodiment of the present invention, the joining point where the at least two conduits become a single conduit may be located in close proximity to the flow control valve or the flow sensor. This close arrangement, at a maximum distance of 100 cm, preferably a maximum distance of 50 cm, and most preferably a maximum distance of 40 cm, 30 cm, 20 cm, 10 cm, or 5 cm, again eliminates a dead-time problem caused by long conduits, making it possible to achieve efficient and exact mixing. The term “distance” refers to the conduit's length between the flow control valve and the flow sensor and the conduit's length between the flow control valve or the flow sensor and the joining point.

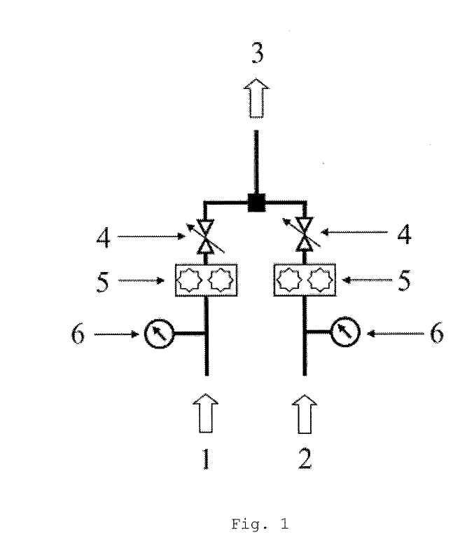

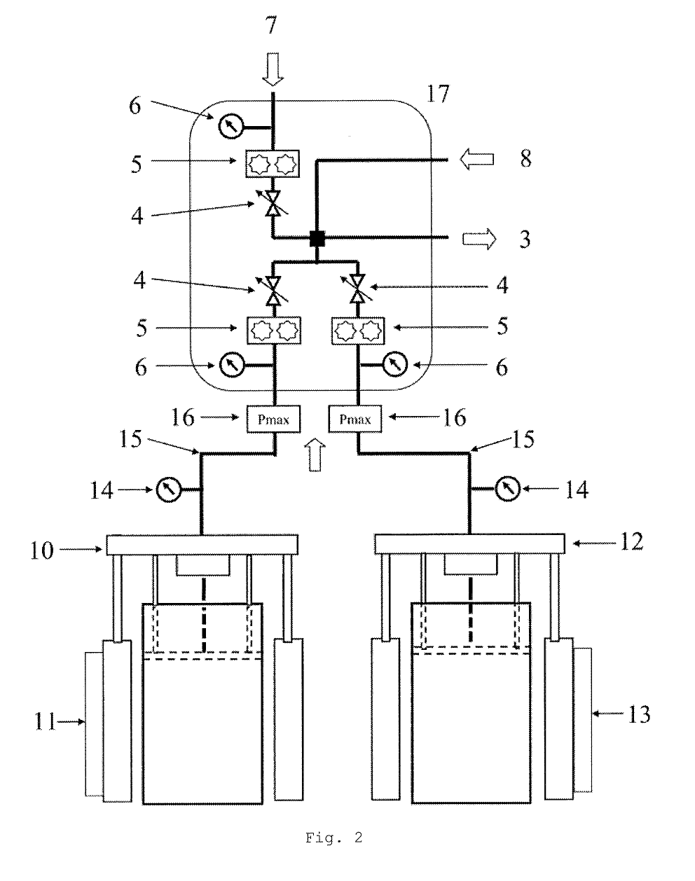

Referring to FIGS. 1-2, in one embodiment of the present invention, the distance between the joining point where the at least two conduits 1, 2 are joined into a single conduit 3 and the flow control valve 4 or the flow sensor 5 may be defined as the ratio between the conduit's length and its diameter, amounting to a maximum ratio of 70:1, preferably to a maximum ratio of 50:1, and more preferably a maximum ratio of 30:1. These ratios represent the conduit's maximum length in relation to its diameter. If the ratio of the conduit's length to its diameter is 70:1, it is possible to achieve an excellent mixing. For example, if the conduit is 1 m long, its maximum diameter is 14.3 mm. A ratio of 50:1 is preferred and a ratio of 30:1 is particularly preferred, since an even better mixing can be achieved at these ratios. The maximum ratio may also be 60:1, 40:1, 20:1, 10:1, 5:1, 4:1, 3:1, 2:1, or 1:1.

In still another embodiment, the joining point where the at least two conduits are joined into a single conduit may be located directly adjacent to the flow control valve or the flow sensor. This eliminates the dead-time problem caused by a long conduit, making it possible to achieve efficient and exact mixing.

In another embodiment, the flow sensor may be a volumeter, a flow meter or a differential pressure flow sensor. Various flow sensors are known in the art. Flow sensors are classified into volumeters (i.e., volumetric flow meters) and flow meters. Volumeters (i.e., volumetric flow meters) include direct meters (i.e., displacement meters), such as oval-wheel meters, oscillating piston meters, or rotary piston meters, and indirect meters, such as turbine wheel meters, impeller meters, hydrometric vanes, worm wheel meters, vortex-shedding meters, or spiral flow meters. Flow meters include volumetric flow meters, such as differential pressure measuring processes, rotameters, magnetic induction flow meters, or ultrasound flow meters, as well as mass flow meters, such as Coriolis mass flow meters or thermal mass flow meters. A differential pressure flow sensor measures the pressure before and after the flow control valve and deducts the flow rate from the pressure difference. In case of a differential pressure flow sensor, the phrases/terms “in close proximity”, “distance” and “ratio between the conduit's length and diameter” refer to the distance between the flow control valve and the pressure measuring device which is located before the flow control valve in the flow direction, and to the distance between the flow control valve and the pressure measuring device which is located after the flow control valve in the flow direction. This means that in case of differential pressure flow sensors, two distances which both have to comply with the above requirements have to be taken into account.

In one embodiment of the present invention, at least one additional conduit may be provided, the additional conduit terminating in the conduit 1, 2 or the conduit 3. This additional conduit allows for adding further liquids.

In another embodiment of the present invention, the at least one additional conduit terminating in the conduit 1, 2 or the conduit 3 may include a flow sensor and a flow control valve or a pump arranged in any order and in close proximity and particularly directly adjacent to each other, with the distance between the flow control valve and the flow sensor being preferably defined as the ratio between the conduit's length and its diameter and amounting to a maximum of 70:1, preferably a maximum of 50:1, and more preferably a maximum of 30:1. Such a conduit is perfectly suited for adding additives. The phrase “in close proximity” is defined as above. These ratios state the conduit's maximum length in relation to its diameter. If the ratio of the conduit's length to its diameter is 70:1, it is possible to achieve an excellent mixing. As such, if the conduit is 1 m long, for example, its diameter is maximally 14.3 mm. A ratio of 50:1 is preferred and a ratio of 30:1 is more preferable, since an even better mixing may be achieved at these ratios. The ratio may also be a maximum of 60:1, 40:1, 20:1, 10:1, 5:1, 4:1, 3:1, 2:1, or 1:1.

In still another embodiment of the present invention, the flow sensor and the flow control valve or the pump within the at least one additional conduit may be located in close proximity and particularly directly adjacent to the conduit or the conduit, the distance between the flow control valve 4 and the flow sensor 5 or the pump to the conduit 1, 2 or the conduit 3 being preferably defined as the ratio between the conduit's 1, 2 length and its diameter or the conduit's 3 length and its diameter, and amounting to a maximum of 70:1, preferably to a maximum of 50:1, and more preferably to a maximum of 30:1. An arrangement in close proximity or directly adjacent to each other eliminates the dead time problem caused by a long conduit, making it possible to achieve efficient and exact mixing. These ratios state the conduit's maximum length in relation to its diameter. If the ratio of the conduit's length to its diameter is 70:1, it is possible to achieve an excellent mixing. If the conduit is 1 m long, for example, its diameter is maximally 14.3 mm. A ratio of 50:1 is preferred and a ratio of 30:1 being particularly preferred, since an even better mixing can be achieved at these ratios. The ratio may also be a maximum of 60:1, 40:1, 20:1m, 10:1, 5:1, 4:1, 3:1, 2:1, or 1:1.

In another embodiment of the present invention, the liquid may have a viscosity ranging from 5,000 mPa·s to 3,000,000 mPa·s. This means that the mixing device is suited for liquids with viscosities ranging from 5,000 mPa·s to 3,000,000 mPa·s. Such liquids are particularly preferred for industrial applications. Additives may, for example, have viscosities from 5,000 mPa·s to 300,000 mPa·s.

In one embodiment of the present invention, the flow control valve may be replaced by a pump or digital hydraulic equipment. In the same way as a flow control valve, the pump acts as a flow control element and may increase or reduce the system pressure. This pump does not replace the feeding pump at the material containers which creates the system pressure. If the pump is located in close proximity to the flow sensor or directly adjacent to it, it is also possible to achieve excellent mixing using a pump, without disturbing influences such as very long conduits or hydraulic fixtures (dead-time elements). Digital hydraulic equipment refers to a valve which can only assume two switching positions: on or off. This creates an intermittent delivery, the digital hydraulic equipment becoming similar to a continuous delivery with increasing frequency, as the switching times become so short that the differences between delivery and non-delivery become too insignificant to be detectable. Switching times of 5 Hz result in a delivery with few intermittences; if the switching time is further increased, for example, to 10 Hz or more, for example, to 20 Hz, 30 Hz, 40 Hz, 50 Hz, or 100 Hz, a substantially non-intermittent delivery may be achieved.

In one embodiment of the present invention, the mixing device may additionally comprise at least two containers, each holding a liquid; at least two pumps for delivering the liquids; and a follower plate for a container, the follower plate being placed on the liquid's surface and sealing the container, and the conduits being connected downstream of the pumps in the feeding direction.

With these additional components, the mixing device is complete and ready to use. The containers holding the liquids are, of course, supplied separately and then inserted into the mixing device.

In one embodiment, the pumps may be gear pumps or eccentric screw pumps or extrusion pumps or screw spindle pumps. Screw spindle pumps supply a uniform and non-intermittent material flow, which is advantageous for further mixing the liquids, as the control is much easier as there are no peaks which have to be compensated.

In one embodiment of the present invention, sensors measuring the levels within the containers based on the follower plates' positions and being connected to a control unit may be arranged within the mixing device. The control unit is, in turn, connected to the pump and the flow control valve and the flow sensor, and controls the pumps and the flow control valve so that at least two containers are evenly emptied. The even emptying of two containers, for example, is particularly important for batch operations, as every container has its own batch number and there might be slight variations between different batches. For this reason, an incompletely emptied container cannot be used for mixing together with a new container; the residual content has to be disposed of at the respective operator's expense. The arrangement of a sensor measuring the level within the container based on the follower plates' positions and controlling its emptying via the control unit avoids residual liquid from remaining in a container—that is, the two containers are completely emptied. For production reasons, it may also happen that the two containers used are not filled to the same level (this may, among other things, also be due to different viscosities of the liquids contained therein). In this case, it is necessary to adequately adjust the levels to one another.

Another aspect of the present invention provides a process for mixing at least two liquids. The process comprises the following steps:

a) pumping a liquid from a container into a conduit;

b) feeding the liquid via the conduit to a flow sensor and a flow control valve which, in the flow direction, is located either up- or downstream of the flow sensor, the flow sensor and the flow control valve being arranged in the conduit in any order in close proximity, particularly directly adjacent, to each other, the distance between flow control valve and the flow sensor being preferably defined as the ratio between the conduit's length and its diameter and amounting to a maximum of 70:1, preferably to a maximum of 50:1, and more preferably to a maximum of 30:1;

c) controlling the flow rate by the flow control valve;

d) feeding the desired liquid flow into a conduit into which at least one further liquid which is, for example, delivered by a separate conduit or in the same way as in the steps a) to c) is introduced, whereby these liquids are mixed; and

e) applying the mixture at the desired location or introducing the mixture into a device for further processing.

It is possible to use a device, such as the above-described device, in this process. The process allows for an exact control of the mixing ratio, which can be readjusted again and again in the course of the process and then applied immediately. There is no time lag after setting a correct mixing ratio. The phrase “immediately upstream or downstream of” means that there is no space between the flow control valve and the flow sensor. If necessary, there may, however, be a small space between the flow control valve and the flow sensor, for example a maximum distance of 100 cm, preferably a maximum distance of 50 cm, 40 cm, 30 cm, 20 cm, 10 cm, or 5 cm. The ratios described above represent the conduit's maximum length in relation to its diameter. If the ratio of the conduit's length to its diameter is 70:1, it is possible to achieve an excellent mixing. If the conduit is 1 m long, its diameter is maximally 14.3 mm. A ratio of 50:1 is preferred, a ratio of 30:1 being particularly preferred, since an even better mixing can be achieved at these ratios. The ratio may also be a maximum of 60:1, 40:1, 20:1, 10:1, 5:1, 4:1, 3:1, 2:1, or 1:1.

In one embodiment of the present invention, the mixing in step d) may take place at the joining point of the at least two conduits, the joining point being located in close proximity, particularly directly adjacent, to the flow control valve or the flow sensor, the distance between the joining point where the at least two conduits are joined into a single conduit and the flow control valve or the flow sensor being preferably defined as the ratio between the conduit's length and its diameter, amounting to a maximum of 70:1, preferably to a maximum of 50:1, and particularly to a maximum of 30:1. This eliminates the dead-time problems associated with long conduits, leading to better mixing results. The ratios state the conduit's maximum length in relation to its diameter. If the ratio of the conduit's length to its diameter is 70:1, it is possible to achieve an excellent mixing. If the conduit is 1 m long, its diameter is maximally 14.3 mm. A ratio of 50:1 is preferred, a ratio of 30:1 being particularly preferred, since an even better mixing can be achieved at these ratios. The ratio may also be a maximum of 60:1, 40:1, 20:1, 10:1, 5:1, 4:1, 3:1, 2:1, or 1:1.

In one embodiment, the pumping in step a) may be achieved by a gear pump or an eccentric screw pump or and extrusion pump or a screw spindle pump. A screw spindle pump delivers the material non-intermittently, and thus is the ideal mechanism for delivering the material, as it is easy to measure and thus mix a non-intermittent material flow.

In another embodiment of the invention, the flow control valve may be replaced by a pump or digital hydraulic equipment. In the same way as a flow control valve, the pump functions as a flow control element and may increase or reduce the system pressure. This pump does not replace the feeding pump at the material containers, which generate the system pressure. As the pump is located directly adjacent to the flow sensor, it is also possible to achieve excellent mixing by means of said pump, without any disturbing influences such as very long conduits or hydraulic fittings (dead-time elements). Digital hydraulic equipment refers to a valve which can only assume two switching positions: on or off. This creates an intermittent delivery, the digital hydraulic equipment becoming similar to a continuous delivery with increasing frequency, as the switching times become so short that the differences between delivery and non-delivery become too insignificant to be detectable. Switching times of 5 Hz results in a delivery with few intermittences. If the switching time is further increased, for example, to 10 Hz or more, for example, to 20 Hz, 30 Hz, 40 Hz, 50 Hz, or 100 Hz, a substantially non-intermittent delivery can be achieved.

In one embodiment of the invention, the flow sensor may be a volumeter, a flow meter or a differential pressure flow sensor. Various flow sensors are known in the art. Flow sensors are classified into volumeters (i.e., volumetric flow meters) and flow meters. Volumeters (i.e., volumetric flow meters) include direct meters (displacement meters), such as oval-wheel meters, oscillating piston meters, or rotary piston meters, and indirect meters, such as turbine wheel meters, impeller meters, hydrometric vanes, worm wheel meters, vortex-shedding meters, or spiral flow meters. Flow meters include volumetric flow meters, such as differential pressure measuring processes, rotameters, magnetic induction flow meters, or ultrasound flow meters, as well as mass flow meters, such as Coriolis mass flow meters or thermal mass flow meters. A differential pressure flow sensor measures the pressure before and after the flow control valve and deducts the flow rate from the pressure difference. In case of a differential pressure flow sensor, the phrases/terms “in close proximity”, “distance” and “ratio between the conduit's length and diameter” refer to the distance between the flow control valve and the pressure measuring device which is located before the flow control valve in the flow direction, and to the distance between the flow control valve and the pressure measuring device which is located after the flow control valve in the flow direction.

This means that, in case of differential pressure flow sensors, two distances which both have to comply with the above requirements have to be taken into account.

In another embodiment of the present invention, the liquid may have a viscosity ranging from 5,000 mPa·s to 3,000,000 mPa·s. This means that the process is suited for a liquid having a viscosity ranging from 5,000 mPa·s to 3,000,000 mPa·s. Such liquids are particularly preferred for industrial applications.

In one embodiment of the invention, sensors arranged in the mixing device may measure the levels within the containers based on the follower plates' positions, the sensors being connected to a control unit. The control unit, in turn, is connected to the pump and the flow control valve and the flow sensor, and controls the pumps and the flow control valve so that at least two containers are evenly emptied. The even emptying of two containers, for example, is particularly important for batch operations, as every container has its own batch number and there might be slight variations between different batches. For this reason, an incompletely emptied container cannot be used for mixing together with a new container, and the residual content has to be disposed of at the respective operator's expense. The arrangement of a sensor measuring the level within the container based on the follower plates' positions and controlling its emptying via the control unit avoids the situation that residual liquid remains in a container; i.e., the two containers are completely emptied. For production reasons, it may also happen that the two containers used are not filled to the same level (this may, among other things, may also be due to different viscosities of the liquids contained therein). In this case, it is necessary to adequately adjust the levels to one another.

### Example 1: Mixing at Least Two Liquids

Referring to FIGS. 1-2, the material is pumped out of the material container by feeding pumps, such as a gear pump or an eccentric screw pump or an extrusion pump or a screw spindle pump or any other pump. The material is then transported to the processing unit via a tubing 1. Pressure control valves may optionally mechanically control and maintain a constant material pressure. It is also possible to control the feeding pumps by pressure sensors, so that the pressure at the processing unit remains constant. Slight pressure variations may be controlled by volumetric measurements. The material flow required for each component is set by a flow control valve 4. Upstream or downstream of the valve 4, the flow rate is measured, for example, by a flow sensor 5. The material transported via the other conduit 2 according to any or the same principle is then introduced into a common conduit 3, and the mixture is fed to the processing process. Further conduits which transport materials for the processing process, which is delivered in any or the above-described way, may enter into the conduit 3.

The flow control valve 4 and the flow sensor 5 may be arranged in any order in close proximity to each other. The distance between the flow control valve 4 and the flow sensor 5 may be defined as the ratio between the conduit's 1, 2 length to its diameter, preferably amounting to a maximum of 70:1, more preferably to a maximum of 50:1, and most preferably to a maximum of 30:1. The flow sensor 5 and the flow control valve 4 may be arranged in any order directly adjacent to each other.

The distance between the flow control valve 4 and the flow sensor 5 may be a maximum of 100 cm, and preferably a maximum of 50 cm, 40 cm, 30 cm, 20 cm, 10 cm, or 5 cm.

The distance between the flow control valve 4 and the flow sensor 5 may also be defined as a ratio between the conduit's 1, 2 length and its diameter. The ratio between length and diameter of conduit 1, 2 is a maximum of 70:1, preferably a maximum of 50:1, and more preferably a maximum of 30:1. It will be understood that the ratio may alternatively be a maximum of, for example, 60:1, 40:1, 20:1, 10:1, 5:1, 4:1, 3:1, 2:1 or 1:1. Table 1 below provides an overview of ratios according to the present invention.

TABLE 1
Ratio between conduit length and diameter according to the
present invention

| length | diameter | ratio of |
|---|---|---|
| [mm] | [mm] | length:diameter |
| 1000 | 14.3 | 70 |
| 1000 | 16.7 | 60 |
| 1000 | 20.0 | 50 |
| 1000 | 25.0 | 40 |
| 1000 | 33.3 | 30 |
| 1000 | 50.0 | 20 |
| 1000 | 100.0 | 10 |
| 1000 | 200.0 | 5 |
| 1000 | 250.0 | 4 |
| 1000 | 333.3 | 3 |
| 1000 | 500.0 | 2 |
| 1000 | 1000.0 | 1 |
| 900 | 12.9 | 70 |
| 900 | 15.0 | 60 |
| 900 | 18.0 | 50 |
| 900 | 22.5 | 40 |
| 900 | 30.0 | 30 |
| 900 | 45.0 | 20 |
| 900 | 90.0 | 10 |
| 900 | 180.0 | 5 |
| 900 | 225.0 | 4 |
| 900 | 300.0 | 3 |
| 900 | 450.0 | 2 |
| 900 | 900.0 | 1 |
| 800 | 11.4 | 70 |
| 800 | 13.3 | 60 |
| 800 | 16.0 | 50 |
| 800 | 20.0 | 40 |
| 800 | 26.7 | 30 |
| 800 | 40.0 | 20 |
| 800 | 80.0 | 10 |
| 800 | 160.0 | 5 |
| 800 | 200.0 | 4 |
| 800 | 266.7 | 3 |
| 800 | 400.0 | 2 |
| 800 | 800.0 | 1 |
| 700 | 10.0 | 70 |
| 700 | 11.7 | 60 |
| 700 | 14.0 | 50 |
| 700 | 17.5 | 40 |
| 700 | 23.3 | 30 |
| 700 | 35.0 | 20 |
| 700 | 70.0 | 10 |
| 700 | 140.0 | 5 |
| 700 | 175.0 | 4 |
| 700 | 233.3 | 3 |
| 700 | 350.0 | 2 |
| 700 | 700.0 | 1 |
| 600 | 8.6 | 70 |
| 600 | 10.0 | 60 |
| 600 | 12.0 | 50 |
| 600 | 15.0 | 40 |
| 600 | 20.0 | 30 |
| 600 | 30.0 | 20 |
| 600 | 60.0 | 10 |
| 600 | 120.0 | 5 |
| 600 | 150.0 | 4 |
| 600 | 200.0 | 3 |
| 600 | 300.0 | 2 |
| 600 | 600.0 | 1 |
| 500 | 7.1 | 70 |
| 500 | 8.3 | 60 |
| 500 | 10.0 | 50 |
| 500 | 12.5 | 40 |
| 500 | 16.7 | 30 |
| 500 | 25.0 | 20 |
| 500 | 50.0 | 10 |
| 500 | 100.0 | 5 |
| 500 | 125.0 | 4 |
| 500 | 166.7 | 3 |
| 500 | 250.0 | 2 |
| 500 | 500.0 | 1 |
| 400 | 5.7 | 70 |
| 400 | 6.7 | 60 |
| 400 | 8.0 | 50 |
| 400 | 10.0 | 40 |
| 400 | 13.3 | 30 |
| 400 | 20.0 | 20 |
| 400 | 40.0 | 10 |
| 400 | 80.0 | 5 |
| 400 | 100.0 | 4 |
| 400 | 133.3 | 3 |
| 400 | 200.0 | 2 |
| 400 | 400.0 | 1 |
| 300 | 4.3 | 70 |
| 300 | 5.0 | 60 |
| 300 | 6.0 | 50 |
| 300 | 7.5 | 40 |
| 300 | 10.0 | 30 |
| 300 | 15.0 | 20 |
| 300 | 30.0 | 10 |
| 300 | 60.0 | 5 |
| 300 | 75.0 | 4 |
| 300 | 100.0 | 3 |
| 300 | 150.0 | 2 |
| 300 | 300.0 | 1 |
| 200 | 2.9 | 70 |
| 200 | 3.3 | 60 |
| 200 | 4.0 | 50 |
| 200 | 5.0 | 40 |
| 200 | 6.7 | 30 |
| 200 | 10.0 | 20 |
| 200 | 20.0 | 10 |
| 200 | 40.0 | 5 |
| 200 | 50.0 | 4 |
| 200 | 66.7 | 3 |
| 200 | 100.0 | 2 |
| 200 | 200.0 | 1 |
| 100 | 1.4 | 70 |
| 100 | 1.7 | 60 |
| 100 | 2.0 | 50 |
| 100 | 2.5 | 40 |
| 100 | 3.3 | 30 |
| 100 | 5.0 | 20 |
| 100 | 10.0 | 10 |
| 100 | 20.0 | 5 |
| 100 | 25.0 | 4 |
| 100 | 33.3 | 3 |
| 100 | 50.0 | 2 |
| 100 | 100.0 | 1 |
| 50 | 0.7 | 70 |
| 50 | 0.8 | 60 |
| 50 | 1.0 | 50 |
| 50 | 1.3 | 40 |
| 50 | 1.7 | 30 |
| 50 | 2.5 | 20 |
| 50 | 5.0 | 10 |
| 50 | 10.0 | 5 |
| 50 | 12.5 | 4 |
| 50 | 16.7 | 3 |
| 50 | 25.0 | 2 |
| 50 | 50.0 | 1 |
| 30 | 0.4 | 70 |
| 30 | 0.5 | 60 |
| 30 | 0.6 | 50 |
| 30 | 0.8 | 40 |
| 30 | 1.0 | 30 |
| 30 | 1.5 | 20 |
| 30 | 3.0 | 10 |
| 30 | 6.0 | 5 |
| 30 | 7.5 | 4 |
| 30 | 10.0 | 3 |
| 30 | 15.0 | 2 |
| 30 | 30.0 | 1 |
| 20 | 0.3 | 70 |
| 20 | 0.3 | 60 |
| 20 | 0.4 | 50 |
| 20 | 0.5 | 40 |
| 20 | 0.7 | 30 |
| 20 | 1.0 | 20 |
| 20 | 2.0 | 10 |
| 20 | 4.0 | 5 |
| 20 | 5.0 | 4 |
| 20 | 6.7 | 3 |
| 20 | 10.0 | 2 |
| 20 | 20.0 | 1 |
| 10 | 0.1 | 70 |
| 10 | 0.2 | 60 |
| 10 | 0.2 | 50 |
| 10 | 0.3 | 40 |
| 10 | 0.3 | 30 |
| 10 | 0.5 | 20 |
| 10 | 1.0 | 10 |
| 10 | 2.0 | 5 |
| 10 | 2.5 | 4 |
| 10 | 3.3 | 3 |
| 10 | 5.0 | 2 |
| 10 | 10.0 | 1 |

The distance between the joining point where the at least two conduits 1, 2 are joined into a single conduit 3 and the flow control valve 4 or the flow sensor 5 may also correspond to the above-mentioned ratios and dimensions.

It is possible to mix liquids to pasty media which are externally fed into the mixing device by pre-feeding facilities (e.g., barrel lifting devices with 20 1 Pail Kit or 200 1 Drum Kit Containers). The liquids may be, for example, liquids having viscosities ranging from 5,000 mPa·s to 3,000,000 mPa·s, 100,000 mPa·s to 3,000,000 mPa·s, 500,000 mPa·s to 3,000,000 mPa·s, or 1,000,000 mPa·s to 3,000,000 mPa·s. At least two components, in some cases also one component and one additive, are mixed at a variable mixing ratio. It is possible to add additional components, such as additives and dyes, at lower amounts (lower viscosities). They are added continuously and under constant monitoring. The mixing ratio is kept constant over an entire cycle, with very few deviations.

The flow rate of every component is altered by a flow control valve 4 directly at the processing unit. It is continuously adjustable from 0 to 100%. A measuring device, such as a flow sensor 5, which is located either directly upstream or downstream of the valve, measures the current flow rate. The feeding pressure to the individual valves is always kept constant. The system corresponds to a closed control loop in which all disturbing factors are taken into account. In the hydraulic system which is to be controlled, the distances between sensors and actuators are very short, resulting in fewer disturbing influences, which means that the system can be exactly controlled by simple methods.

The flow sensor 5 may be a volumeter, a flow meter or a differential pressure flow sensor. Flow sensors are classified into volumeters (i.e., volumetric flow meters) and flow meters. Volumeters (i.e., volumetric flow meters) include direct meters (displacement meters), such as oval-wheel meters, oscillating piston meters, or rotary piston meters, and indirect meters, such as turbine wheel meters, impeller meters, hydrometric vanes, worm wheel meters, vortex-shedding meters, or spiral flow meters. Flow meters include volumetric flow meters, such as differential pressure measuring processes, rotameters, magnetic induction flow meters, or ultrasound flow meters, as well as mass flow meters, such as Coriolis mass flow meters or thermal mass flow meters. A differential pressure flow sensor measures the pressure before and after the flow control valve and deducts the flow rate from the pressure difference. In case of a differential pressure flow sensor, the phrases/terms “in close proximity”, “distance” and “ratio between the conduit's length and diameter” refer to the distance between the flow control valve and the pressure measuring device which is located before the flow control valve in the flow direction, and to the distance between the flow control valve and the pressure measuring device which is located after the flow control valve in the flow direction. This means that in case of differential pressure flow sensors, two distances which both have to comply with the above requirements have to be taken into account.

The mixing device may be equipped with a check valve to prevent components from flowing back into the feeding conduit of another component. Generally, this function is fulfilled by the flow control valve, as the flow sensors recognize any backflow and can prevent it.

The flow control valve 4 may be replaced by a pump. In the same way as a flow control valve 4, the pump functions as a flow control element and may increase or reduce the system pressure. This pump does not replace the feeding pump at the material containers, which generate the system pressure. As the pump is located very close or directly adjacent to the flow sensor 5, it is also possible to achieve excellent mixing by the pump, without any disturbing influences such as very long conduits or hydraulic fittings (dead-time elements).

The flow control valve 4 may also be replaced by digital hydraulic equipment. Digital hydraulic equipment refers to a valve which can only assume two switching positions: on or off. This creates an intermittent delivery, the digital hydraulic equipment becoming similar to a continuous delivery with increasing frequency, as the switching times become so short that the differences between delivery and non-delivery become too insignificant to be detectable. Switching times of 5 Hz result in a delivery with few intermittences. If the switching time is further increased, for example, to 10 Hz or more, for example, to 20 Hz, 30 Hz, 40 Hz, 50 Hz, or 100 Hz, a substantially non-intermittent delivery can be achieved.

### Example 2: Injection Molding

Liquid silicone rubber (LSR) is most commonly used in traditional injection molding processes using an injection molding device. In this process, the material is mixed in the device described in Example 1 at a mixing ratio of 1:1 and dosed into the screw of the injection molding device. The injection molding device then injects the material into a hot mold.

### Example 3: Direct Casting

Other areas of application of the mixing device include direct casting, in which components directly deliver the material into a tool without using an injection molding device. It is, of course, also possible to mix other materials, such as resins and adhesives, food. The material quantities required are for large-volume parts produced by a casting process and are often very high. The feed pump directly injects the material via a constant flow mix facility into the tool. The injection profile (e.g., quantity, time) may be set via a user interface. Optionally, the injection may be controlled by sensors for sensing the pressure inside the mold.

### Example 4: Adding Additives (Dyes)

The volume flow of the main components is controlled based on the current flow rate and the control variable of the flow control valve 4. The additive is constantly added to the main volume flow and thus documented.

Option 1: The additive is added controlled by a flow control valve and a measuring device.

Option 2: The additive is added continuously to the volume flow using an injection unit.

Option 3: The additive is added discontinuously to the volume flow by a pulsed dye valve (each pulse injects an amount X into the main flow).

Option 4: The additive is added controlled by a pump, instead of a flow control valve, and a measuring device.

### Example 5: The Operating Principle of the Adjustment of the Levels Within Barrels

As it is possible that the materials to be mixed have different viscosities, this may lead to an unequal emptying of material containers in devices with volumetric delivery volumes and a mixing ratio of 1:1. In practice, the containers supplied by the manufacturers are not filled to the same levels in many cases (i.e., different volumes of components A and B). As the containers A and B have to be emptied simultaneously (i.e., batch process) and cannot be selectively replaced, a fixed mixing ratio results in the containers being emptied unequally and in residual material in one of the containers, while the other container is already completely empty. This means that in some cases there may be 10% residual material left in one of the containers, which cannot be processed and thus has to be disposed of as hazardous waste. This results in an increased environmental burden and in higher costs for the user.

Depending on the manufacturers, silicones with a slight deviation of +−5% (depending on the manufacturer's fact sheet) may be mixed. This allows for approximation of the mixing ratio, so that the containers are emptied simultaneously (if the level does not exceed +5% of maximum deviation).

Referring to FIG. 2, the material containers are replaced at the same time, and, after the ventilating process, the levels within the containers are determined based on the follower plates' positions by a sensor 11, 13 arranged in the mixing device. The required mixing ratio is calculated based on the deviation. A control unit connected to the pump as well as the flow control valve 4 and the flow sensor 5 then controls the pumps and the flow control valve 4 so that the two containers are equally and completely emptied. The flow sensor 5 provides information on the material flow. The required mixing ratio is recalculated in the course of production to compensate for any viscosity differences in the containers.

### Example 6: The Operating Principle of Tandem Applications

It is possible to feed several machines using a single material feeding unit (feeding pump). Each unit is provided with a constant flow mix unit which communicates with a superior control via a data line. This control controls several constant flow mix units and the material feeding pumps and, at the same time, the levels within the barrels. The individual constant flow mix units correct the mixing ratio within the set maximum tolerance range (each constant flow mix unit separately) so that the barrels are emptied equally and no residual material is left behind. Additionally, several feeding pumps may be coupled to form a group to make sure that the system is permanently supplied with material and the production process is not interrupted when barrels need to be replaced. As the mixing ratios of the constant flow units are separately controlled, several users of material feeding units can be simultaneously supplied with material, which used to be impossible using prior art systems. Additionally, compensators which stabilize the system pressure in case of parallel supply and keep it constant may be integrated into the supply conduits.

### Example 7: Automatic Verification

In order to be able to guarantee the production quality standards, devices, injection molding machines, and tools have to be verified. In the case of dosing devices, this process is mostly restricted to ensuring compliance with a certain mixing ratio. Normally, the follower plates' positions are recorded and then changes which have occurred are documented after a certain production period. It cannot be verified, whether the mixing ratio did not comply with the specifications in the meantime.

The device is able to verify itself based on international standards which are, for example, set by quality assurance systems such as ISO 9001:2010. The results may be directly transferred to a storage device or via data transfer. Documentation, for example, includes the recording of all process parameters in a common data format; charting the data at the HMI; and recording process data for a set number of hours, weeks or per log file in which changes are also recorded.

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention as defined by the appended claims.

1-23. (canceled)

24. A mixing device for mixing at least two liquids, the mixing device comprising:
at least two conduits (1, 2) which are joined at a joining point to become a single conduit (3),
wherein at least one of the conduits (1, 2) has a flow control valve (4) and a flow sensor (5), and
wherein the flow control valve (4) and the flow sensor (5) are arranged in any order and in close proximity to each other.

25. The mixing device according to claim 24, wherein each of the at least two conduits (1, 2) has a flow control valve (4) and a flow sensor (5), and wherein each flow control valve (4) and each flow sensor (5) are arranged in any order and in close proximity to each other.

26. The mixing device according to claim 24, wherein a distance between the flow control valve (4) and the flow sensor (5) is defined as a ratio of a length of the conduit (1,2) to a diameter of the conduit (1, 2), the ratio being a maximum of 70:1.

27. The mixing device according to claim 24, wherein the flow sensor (5) and the flow control valve (4) are arranged in any order directly adjacent to each other.

28. The mixing device according to claim 24, wherein the joining point is situated in close proximity to the flow control valve (4) or the flow sensor (5).

29. The mixing device according to claim 24, wherein a distance between the joining point and the flow control valve (4) or the flow sensor (5) is defined as a ratio between a length of the conduit (1,2) to a diameter of the conduit (1, 2), the ratio being a maximum of 70:1.

30. The mixing device according to claim 24, wherein the joining point is located directly adjacent to the flow control valve (4) or the flow sensor (5).

31. The mixing device according to claim 24, wherein the flow sensor (5) is selected from the group consisting of a volumeter, a flow meter and a differential pressure flow sensor.

32. The mixing device according to claim 24, further comprising at least one additional conduit terminating in at least one of the at least two conduits (1, 2) or the single conduit (3) is provided.

33. The mixing device according to claim 32, wherein the at least one additional conduit has a flow sensor (5) and a flow control valve (4), the flow sensor'(5) and the flow control valve (4) of the at least one additional conduit being arranged in any order in close proximity, a distance between the flow control valve (4) and the flow sensor (5) of the at least one additional conduit being defined as a ratio between a length of the conduit (1,2) and a diameter of the conduit (1, 2), the ratio being a maximum of 70:1.

34. The mixing device according to claim 33, wherein the flow sensor (5) and the flow control valve (4) of the at least one additional conduit are arranged in close proximity to the at least two conduits (1, 2) or the single conduit (3), a distance between the flow control valve (4) and the flow sensor (5) of the at least one additional conduit or between a pump and the at least two conduits (1, 2) or the single conduit (3) being defined as a ratio between the length and the diameter of the at least two conduits (1, 2) for between a length and a diameter of the single conduit (3), the ratio being a maximum of 70:1.

35. The mixing device according to claim 24, wherein the liquid has a viscosity ranging from 5,000 mPa·s to 3,000,000 mPa·s.

36. The mixing device according to claim 24, wherein the flow control valve (4) is replaced by a pump or digital hydraulic equipment.

37. The mixing device according to claim 24, further comprising:
at least two containers, each holding a liquid;
at least two pumps for delivering the liquids; and
a follower plate for each of the at least two containers, each follower plate being placed on a surface of the liquid and sealing the respective container, the at least two conduits (1, 2) being connected downstream of the at least two pumps in a feeding direction.

38. The mixing device according to claim 37, wherein the at least two pumps are one of gear pumps, eccentric screw pumps, extrusion pumps or screw spindle pumps.

39. The mixing device according to claim 37, further comprising sensors (11, 13) located within the mixing device, the sensors measuring a level within the at least two containers based on positions of the follower plates and being connected to a control unit, the control unit being connected to the at least two pumps, the flow control valve (4) and the flow sensor (5), the pumps and the flow control valve (4) being controllable via the control unit to evenly empty the at least two containers.

40. A process for mixing at least two liquids comprising the following steps:
a) pumping a first liquid from a container into a first conduit (1);
b) feeding the first liquid via the conduit (1) to a flow sensor (5) and a flow control valve (4), the flow control valve being arranged either upstream or downstream of the flow sensor (5) in a feeding direction, the flow sensor (5) and the flow control valve (4) being mounted within the conduit (1) and being arranged in any order in close proximity, a distance between the flow control valve (4) and the flow sensor (5) being defined as a ratio between a length and a diameter of the first conduit, the ratio being a maximum of max. 70:1;
c) controlling a flow rate by the flow control valve (4);
d) delivering a second liquid into a second conduit (2) in any manner on in a same manner as in steps a) to c), and introducing a desired flow rate of the first liquid into a third conduit (3) into which the second liquid is also delivered via the second conduit (2), such that mixing of the first and second liquids is achieved to form a mixture; and
e) applying the mixture at a desired location or introducing the mixture into a desired device for further processing.

41. The process according to claim 40, wherein in step d), the mixing takes place at a joining point where the first and second conduits (1, 2) are joined into the third conduit (3), the joining point being located in close proximity to the flow control valve (4) or the flow sensor (5), a distance between the joining point and flow control valve (4) or the flow sensor (5) being defined as a ratio between a length and a diameter of the first and second conduits (1,2), the ratio being a maximum of 70:1.

42. The process according to claim 40, wherein in step a) the pumping is achieved by a pump selected from the group consisting of a gear pump, an eccentric screw pump, an extrusion pump and a screw spindle pump.

43. The process according to claim 40, wherein the flow control valve (4) is replaced by a pump or digital hydraulic equipment.

44. The process according to claim 40, wherein the flow sensor (5) is selected from the group consisting of a volumeter, a flow meter and a differential pressure flow sensor.

45. The process according to claim 40, wherein the liquid has a viscosity ranging from 5,000 mPa·s to 3,000,000 mPa·s.

46. The process according to claim 40, wherein sensors (11, 13) measure a level of each of the first and second liquids within a respective container based on positions of follower plates, the sensors (11, 13) being connected to a control unit, the control unit being connected to a pump, the flow control valve (4) and the flow sensor (5), the control unit controlling the pump and the flow control valve (4) to evenly empty at least two containers respectively containing the first and second liquids.
